(19) United States
(12) Patent Application Publication
(10) Pub. No.: US 2014/0158556 A1
(43) Pub. Date: Jun. 12, 2014

(54) Platelets Storage Container

(71) Applicant: Marie Joelle Chammas, (US)

(72) Inventor: Marie Joelle Chammas, Walpole, MA (US)

(73) Assignee: Marie Joelle Chammas, Walpole, MA (US)

(21) Appl. No.: 13/711,613

(22) Filed: Dec. 12, 2012

(51) Int. Cl. A61J 1/10

(52) U.S. Cl. CPC A61J 1/10
USPC 206/5

(57) ABSTRACT

A storage container for pathogen reduction and maintaining pH levels for preserved platelets concentrates and other blood products.

### FIELD OF THE INVENTION

This invention relates to an improved RBC, leukocyte, or platelet storage method and composition. More particularly, this invention aims to minimize pathogen contamination of the stored platelet concentrates and of packed platelets suitable for transfusion. This invention also presents a new approach that neutralizes the effect of the citric anticoagulant in the re-infused blood products.

### BACKGROUND OF THE INVENTION

Platelets are small cellular (2 μm to 4 μm) megakaryocytes components of the blood that provide primary hemostasis function that leads to the stop of bleeding. Platelets transfusion is an established medical therapy used to help patient's recovery post major surgeries or post chemotherapy treatments. Platelets are either derived from collected units of human whole blood using special hematology techniques or are directly collected from a healthy human donor using special apheresis systems.

In routine blood banking practice, human platelet concentrates (PC) are prepared by drawing a unit of blood (about 450 ml) into a plastic bag containing an anticoagulant and then centrifuging the blood into three fractions: red cells, plasma, and platelets. The separated platelet fraction is then suspended in approximately 50 ml of plasma. This platelet-containing product is then stored until needed for transfusion into a patient.

After platelets collection they are stored for up to 5 days to be infused in patients. Platelets are stored in bags made of plastic film material with high O₂ and CO₂ permeability to control platelet metabolism and pH level. In order for the platelets to maintain their function for re-infusion, they are stored under constant agitation at 22° C. This storage temperature provides the environment for any viruses or bacteria that are introduced to the blood during the collection process to proliferate and subsequently may cause sepsis complications to the recipient.

In addition to storage time, other storage conditions have been shown to affect platelet metabolism and function. Initial pH, storage temperature, total platelet count, plasma volume, agitation during storage, and hydrogen ion accumulation are some of the factors known to influence the storage of platelets.

A number of other interrelated variables can also affect platelet viability and function during storage, namely, the anticoagulant used for blood collection, the method used to prepare platelet concentrates and the composition, surface area, and thickness of the walls of the storage container.

One of the major problems in PC storage is regulation of pH. Virtually all units of PC show a decrease in pH from their initial value of approximately 7.0. This decrease is primarily due to the production of lactic acid by platelet glycolysis and to a lesser extent to accumulation of CO₂ from oxidative phosphorylation.

As pH level in the stored platelets bag falls from 6.8 to 6.0, the platelets progressively change shape from discs to spheres. In this pH range, the change of shape is reversible if the platelets are resuspended in plasma with physiologic pH. However, if the pH falls below 6.0, a further irreversible change occurs which renders the platelets nonviable after infusion in vivo.

Oxygen supply to the platelets within the plastic bag is also intimately related to pH maintenance. If the supply is sufficient, glucose will be metabolized oxidatively resulting in CO₂ production, which diffuses out of the plastic walls of the PC container. If the supply of oxygen is insufficient, glucose will be metabolized anaerobically, resulting in the production of lactic acid, which must remain within the container and thus lowers the pH. The oxygen tension within the container is governed by several factors: the concentration of platelets which consume oxygen, the permeability of the plastic wall of the PC, the surface area of the container available for gas exchange, and the type of agitation utilized.

The present goal of platelet preservation is to prevent this change in pH and to minimize the pathogens growth in the storage media. There are many attempts in the prior arts to prevent the change in the pH and to eradicate all pathogens. All these methods were founded on chemical and/or radiation treatments of the blood products. Chemicals that proved to be effective in eradicating bacteria and viruses could pose serious side effects on blood cells such as red blood cells (RBC) and platelets.

The object of the current invention is to provide a passive method to prevent unwanted changes in pH and to minimize the bacteria and viruses growth in the blood product storage environment. Whereas the passive method in this invention is not dependent on mixing chemicals with blood products nor utilizes any type of radiation to treat blood products.

### DISCLOSURE OF THE INVENTION

The current invention aims to minimize bacterial contamination of the stored platelets. More specifically to minimize bacterial contamination inside the platelet bag during storage. Therefore, diminishing the risk of septicemia acquired in the course of platelets transfusion. In this invention, the platelet bag is designed to incorporate a sachet that contains adsorbent media. The adsorbent media has inherent tendency to capture bacteria and viruses from solutions. These captured bacteria and viruses are prevented from being mixed with the environment that contains plasma and platelets. The media that is contained inside the sachet is safe when it comes in contact with plasma but in some cases it might cause platelet adhesion or red blood cell Hemolysis when it comes in contact with blood cells. Therefore, it is important to keep the blood cells from contacting the adsorbent media.

For convenience all bacteria, micro-organisms, viruses, cytokines, endotoxins, and toxin will be referred to in this study as pathogens.

The sachet that contains the media is made of biocompatible membrane with porosity that prevents any blood cell from passing through while bacteria and viruses suspended in the plasma can pass freely through the membrane. Typically bacteria are 1 μm (micron) or less in size. Viruses are less than 1 μm in size. Platelets are (2 μm to 4 μm) in size and red blood cells (RBC) are 7 μm in size. Platelets usually have a disc shape that could transform to a spherical shape at cold temperatures. RBCs have a disc shape with 7 μm in diameter and 2 μm thick. White blood cells have a spherical shape with 10 μm in diameter.

Platelets with bacteria and viruses are suspended in the plasma inside the platelet bag. The sachet containing adsorbent media is located inside the platelet bag. Platelets cannot penetrate the sachet membrane and they cannot come in contact with the adsorbent media inside the sachet. Platelets are confined in the space inside the platelet bag but outside the sachet. Bacteria and viruses are floating in the plasma can easily penetrate the sachet membrane. Therefore, the bacteria, viruses, and plasma are located inside the whole space defined by the platelet bag including the sachet. As bacteria and viruses cross through the sachet membrane and come in contact with the adsorbent media inside, they stick to the media surface and become trapped. The majority of the bacteria and the viruses that flow inside the sachet adhere to the adsorbent surface and are prevented from becoming loose. Therefore, they are entrapped inside the sachet and do not intermix with the platelets that float in the plasma outside the sachet. In addition, cytokines, endotoxins, and other micro-organisms and toxins that are suspended in the plasma; are also trapped by the activated carbon inside the sachet. U.S. Pat. No. 6,852,224 by Jagtoyen et al. discloses a filter comprised of activated carbon fibers, wherein said filter has a Virus Removal Index (VRI) of at least about 99%, as measured in accordance with the test method described in the specification. U.S. Pat. No. 4,898,676 by Horowitz discloses a method of using grafted activated carbon to remove bacteria from contaminated water. U.S. Pat. No. 6,989,101 by Cumberland et al. discloses activated carbon media filter for the removal of micro-organism from a medium. There are many research papers and published literature and books supporting the concept of pathogen adsorption by activated carbon and by porous polymeric resins of Styrenic matrix.

When platelets are needed for re-infusion, they are pumped out of the bag with the plasma by gravity or by a pump such as peristaltic pump. The bacteria and viruses that crossed the sachet membrane and were absorbed by the media inside remain in the bag. Therefore, a lesser number of bacteria and viruses are mixed with the platelets when exiting the bag for re-infused. It is obvious that the more bacteria and viruses are absorbed by the media, the smaller their number is with the infused platelet product.

In most blood centers the bag containing the platelets is laid down on a shaker that is continuously agitated at a rate of 70 to 80 cycles per minute. The oscillation movement of the shaker flushes the plasma back and forth inside the bag. This flushing movement generates plasma current that flows in and out the sachet through the porous membrane. Bacteria, micro-organisms, viruses, cytokines, endotoxins, lipids, proteins, and other electrolytes flow through the porous membrane with the plasma, while the platelets and other cells are kept out of the sachet.

In a preferred embodiment the media contained in the sachet is made of activated carbon cloth such as commercially known “Zorflex” that is sold by (Calgon Carbon Corp. Pittsburgh, Pa., USA). Zorflex has large surface area (700-2000 m²/g), being predominately microporous. Bundles of very fine activated carbon fibers are used to weave or knit Zorflex cloth. The cloth can also be impregnated with chemical treatments to make more sensitive to adsorption of particular molecules. Electrostatic forces could be developed within the cloth to enhance its adsorbing efficiency. The cloth can be woven or knitted with different weights and thickness. The media could also be made of particulate (beads, graduals) activated carbons sold by Calgon Carbon Corp. or Norit Americas Inc. (Marshall, Tex., USA). The media could also be made of activated carbon fibers and microfibers sold by Kureha (Tokyo, Japan), or nano-fibers and nano-tubes.

Activated carbon (AC) is adsorbent that is manufactured from a carbon based material. Some of the common carbonaceous substances used as raw materials to make activated carbon are coal lignite, sub-bituminous, and bituminous, coconut shell, petroleum cock, and petroleum pitch. Activated carbon is widely used for water purification applications. Different micro-organism, organic compounds, viruses, bacteria, cysts, volatile organic chemicals are treated by activated carbon. There are many literatures describing the effective use of activated carbon in contamination treatments.

Activated carbons (AC) remove bacteria from the aqueous medium through attractive Van der Waals forces. The AC can also be electrostatic positively or negatively charged to attract ionically charged endotoxins, cytokins, or bacteria membrane. In a study published in October 2011 by V-T Filtergroup (Fiber Filtration BV, Einsteinstraat 8, 3281 NJ Numansdrop, Nederland, Tel: 31 (0) 186 574151) indicated that Zorflex VB carbon cloth was able to capture 99.54% of the tested virus and kill 93% of them. Zorflex VB Plus carbon cloth was able to capture 99.88% of the tested virus and kill 98% of them.

The sachet in the preferred embodiment is made of expanded polytetrafluoroethylene (ePTFE) membrane that is sold by (W. L. Gore & Associates, Inc. Newark, Del., USA) with such a porosity that allows plasma, bacteria, viruses, and prion to pass through. Types of bacteria include but not restricted to Streptococcus pneumonia, Streptococcus, Staphylococcus, Staphylococcus aureus, Escherichia coli, Bacillus, Klebsiella, Serratia, Corynebacteria diphtheria, Mycobacterium tuberculosis, and Chiamydia Pneumonia. Types of viruses include but not restricted to Poxvirus-Variola, Parainfluenza, Respiratory Syncytial, Varicellazoster, HIV, HCV, SARS, Adenovirus, CMV, Togavirus, Echovirus, Rhinovirus, and Parovirus.

In another embodiment, the adsorbent media is made of porous polystyrene resin commercially known as Purolite (Bala Cynwyd, Pa., USA) Large family of polystyrene resins with high BET surface area and high porosity. Some of these resins that are used for this application are PAD550, PAD600, and PAD900. Another family of Purolite resins commercially known as Macronet with resins MN200 and MN400. Another family of porous polystyrene resins is Amberlite XAD16, XAD4, XAD1180, XAD1600, XAD16HP (Rohm and Haas Company, Philadelphia, Pa., USA). Another polymeric adsorbent media that could be used in this embodiment is Dowex optipore L493 supplied by Dow Chemical Company. This porous media has a BET surface area of 400 m²/g to 1300 m²/g is capable to adsorb bacteria and viruses in a fluid environment.

In addition to their porosity and large (BET) surface area characteristics, these resins could also have ion exchange characteristics. Ion exchange resins are classified as cation exchangers, that have positively charged mobile ions available for exchange, and anion exchangers, whose exchangeable ions are negatively charged. Both anion and cation resins are produced from the same basic organic polymers. Resins can be broadly classified as strong or weak acid cation exchangers or strong or weak base anion exchangers.

All these polymeric particulate resins come in spherical shape of different diameter ranging between (0.2 mm to 2 mm) which are too large to penetrate through the sachet membrane. Therefore these resin beads are captured inside the sachet and can not intermix with the platelets outside the sachet.

In other embodiment the sachet walls are coated with hydrogel layer that improves the hemocompatibility of the sachet surface. The hydrogels have thrombo-compatibility characteristics that prevent platelets adhesion to the sachet surface. The hydrogel could be made of material such as Poly (Hydroxyethyl Methacrylate), 2-Hydroxyethyl Methacrylate, or Poly-HEMA also known by CAS Number 25249-16-5. Different classifications of hydrogel based on ionic charges such as anionic, cationic, ampholytic, and neutral hydrogel can be used. Different classifications of hydrogel based on structure such as amorphous, semi-crystalline, and hydrogen-bonded hydrogel can be used. The hydrogel also can be made of Poly (Vinyl alcohol), Poly (N-vinyl 2-pyrrolidone), and Poly (ethylene glycol).

Hydrogel coating of the sachet walls allows for the use of a membrane with porosities that are greater than the size of the platelets.

The sachet Microporous membrane material could be any of the following material but not restricted to Polyethersulfone (PES), Polyester, Polysulfone, Polyvinylidene flouride (PVDF), Nylon, Polytetraflourethylene (PTFE), Cellulose acetate, and Polypropylene.

It should be known that this invention is not restricted to platelet storage bag. It also can be used for concentrated red blood cell (concentrated RBC) storage bag, white blood cell (Leukocytes) storage bag, plasma storage bag, whole blood storage bag, or any combination of RBC, platelets, leukocyets, and plasma.

The porosity of the sachet membrane is selected in accordance with the cell size that is prevented from crossing through the membrane. For example leukocytes are spherical with diameter size (10 μm to 12 μm), RBC size is (7 μm Diameter and 2 μm thick), and Platelets are disc shape with (2 μm to 4 μm) in size. The sachet membrane porosity used in the leukocyte storage bag is larger than the membrane porosity used for the RBC storage bag. The sachet membrane porosity used for the RBC storage bag is larger than the membrane porosity used for the platelets storage bag. The porosity of the sachet membrane used for the whole blood should prevent all cells from passing through, therefore the porosity size should selected to prevent the smallest cell which is the platelet from passing through.

The adsorbent media inside the sachet can be selected from the family of porous polymer resins, activated carbon particulates, or activated carbon cloth. The adsorbent media could be any combination of these activated carbon and porous polymer resins.

In some cases the adsorbent media biocompatibility characteristics can be enhanced by coating the surface. One of the coating techniques known in the industry is hydrogel. One of very well known hydrogel is Poly-HEMA, PHEMA, or Poly (2-hydroxyethyl methacrylate). Other kinds of hydrogel such as Polyvinyl Alcohol (PVA), Polyethylene Glycol (PEG), Polyvinyl pyrrolidone, and Ethylene glycol dimethacrylate (EGDMA) can be used. Other coating techniques that could be used to enhance the biocompatibility characteristics of the adsorbent carbon or resins are Cellulose, Silicone, and Poly-Methyl Methacrylate (PMMA).

Based on the foregoing, an object of the present invention is to provide an improved passive storage system for blood products and more particularly for platelet concentrate for removing contaminants and pathogens from the transfused platelets. A specific object includes providing passive storage system comprising activated carbon fibers which removes a broad spectrum of contaminants, including very small microorganisms such as bacteriophage to much larger pathogens such as E. coli bacteria. Furthermore the storage system comprising polymeric porous resins and ion exchange resins for the removal of pathogens from the transfused platelets.

Activated carbon and porous polymeric resins having a tendency to adsorb bacteria from solutions can be employed, thereby minimizing the risk of septicemia acquired in the course of a transfusion.

The removal of such pathogens from platelets concentrate using the present passive storage without any chemical additive is at a level not previously demonstrated by the prior art.

Another object of the present invention is to provide a method of removing pathogens from blood products, particularly concentrated platelet, using the storage container of the present invention.

Another object of the invention is to provide an article of manufacture comprising the storage container of the present invention.

Another object of the present invention is that the in vivo shelf life of blood platelets can be extended beyond those currently attainable in the prior art by providing adsorbing activated carbon capable of supporting platelet metabolism.

Another object of the present invention is that the in vivo shelf life of blood platelets can be extended beyond those currently attainable in the prior art by providing adsorbing and ionic charged resin capable of supporting platelet metabolism.

Another object of the present invention is to provide a platelet storage system which promotes the preservation of the platelet morphology.

Another object of the present invention is to provide a platelet storage system which buffers the pH of stored platelets.

Another object of the present invention is to provide a platelet storage system which extends the functional life of platelets.

In a different embodiment of the invention, the blood or the blood components are not confined inside a container but rather they are flowing through a system of connecting tubes and containers. For example in apheresis system blood flows from a donor in a closed extracorporeal circuit to be processed by the system and then the blood or certain components of the blood return back to the donor. In this embodiment the blood flows through a mass of activated carbon or porous resin with or without ion exchange characteristics. As it is explained above in this study, the activated carbon and the porous resin capture bacteria, cytokines, endotoxins, and other micro-organisms and toxins that are suspended in the blood. When blood passes through a mass of ionic exchange resin, different types of ions suspended in the blood are captured by the resin.

More specifically, when blood is drawn from an apheresis donor it is mixed with anticoagulant in order to avoid clotting. Depending on the type of the anticoagulant there is a defined ratio for mixing the anticoagulant with blood. The mixture of blood and anticoagulant is called anticoagulated blood. After processing of the anticoagulated blood by the apheresis system, some blood components (Plasma, RBC, or Platelets) are stored in containers for future reinfusion. The rest of the blood components are returned to the donor. It is typical in apheresis procedure to process large amount of donor's blood (in the range of 5 to 6 liters) that flows continuously or in batches (depending on the Apheresis system) from the donor to the system and back again to the donor. The blood flows at a rate that is comfortable to the donor (in a range of 50 to 150 ml/minute) without violating the limit of the allowed extracorporeal volume of the blood. As the blood exits the vein of the donor it is immediately mixed with anticoagulant at a constant ratio. For example for apheresis the ratio is (1:16). As the blood is being processed, it is constantly mixed with anticoagulant. When the blood is returned back to the donor, a large amount of anticoagulant is infused into the donor. For an apheresis procedure that processes 5 liters of blood, more than 300 ml of anticoagulant with citrate content of (0.3 to 0.4 g/100 ml) is infused into the donor. In most cases this amount of citrated anticoagulant causes discomfort to the donor, especially after long apheresis procedures. Approved anticoagulant-preservatives include acid-citrate-dextrose solution (ACD), citrate-phosphate-dextrose solution (CPD), citrate-phosphate-dextrose-dextrose solution (CP2D), and citrate-phosphate-dextrose-adenine solution (CPDA-1). Removing the anticoagulant from the blood that is returned to the donors would increase their level of comfort. Directing the returned blood to pass through a chamber containing ionic exchange resins would help in removing citrate from the blood before it is infused into the donor. More specifically a chamber containing anion exchange resin can remove citrate from the blood. Anion exchange resins, i.e., those possessing functional groups which can undergo reactions with anions in a surrounding solution, particularly weakly basic anion exchange resins, are preferred. Such resins are formed of Styrenic or Acrylic porous matrix with high mechanical stability. Such resins used in the present invention with apheresis systems have the additional properties of adsorbing acids from organic reaction mixtures, exchanging anions in a slightly acidic media, a high exchange capacity, low swelling properties and a tendency to adsorb bacteria from the surrounding solution are particularly advantageous. The anion exchange resin may be used alone or in combination with other anion and/or cation exchange resins suitable for the intended purpose.

Weak Base Anion Exchanger resins are commercially available under the trade name of Amberlite IRA92 or IRA96 from Rohm & Haas Company, Macroporous Polystyrenic Purolite A100 and A835 from Purolite, and Dowex MWA-1 or Dowex M43 from Dow Chemical.

In another embodiment of the present invention a strong base anion exchanger resins such as Purolite A500 and A510 from Purolite are used to extract acidic solution such as citrate from the returned blood.

In another embodiment of the present invention activated carbon is used to extract acidic solution such as citrate from the returned blood.

In another embodiment of the present invention different combinations of activated carbon, weak base anion resin, and strong base anion resin are used to extract acidic solution such as citrate from the returned blood.

In another embodiment adsorbent porous resins with high BET surface area and high porosity such as PAD400 and PAD600 from Purolite, Amberlite XAD4 and XAD16 from Rohm and Haas, and Dowex L493 from Dow Chemical are used in the housing that is positioned on the blood return line. As the blood components are re-infused back into the donor, they are directed to pass through the housing containing the adsorbent porous resins. In most apheresis systems, as the blood is drawn from the donor, processed and returned back to the donor; few red blood cells (RBC) are hemolized (damaged) due to different stresses during the processing steps. Hemolized RBC release hemoglobin to the plasma medium. The free hemoglobin could negatively affect the donor and especially damaging to the kidneys as it is re-infused back with the retuned blood components. The adsorbent porous resins have the capacity to adsorb the free hemoglobin from the returned blood components flow. Therefore preventing the free hemoglobin from being re-infused back into the donor.

In another embodiment activated carbon cloth or activated carbon particulates are used in the housing that is positioned on the return line to adsorb the free hemoglobin from the returned blood products before they are re-infused back into the donor. The activated carbon can be used in this housing with or without the adsorbent porous resins.

Further aspects, features and advantages of the present invention will become more fully apparent from the following description of specific embodiments, the attached drawings and the appended claims; to those skilled in the art to which this invention pertains.

### BRIEF DESCRIPTION OF THE DRAWINGS

The foregoing and other objects, features and advantages of the invention will be apparent from the following more particular description of preferred embodiments of the drawings in which like reference characters refer to the same parts throughout the different views. The drawings are not necessarily to scale, emphasis instead being placed upon illustrating the principles of the invention.

FIG. 1 A schematic top view of the storage container demonstrating the activated carbon cloth enveloped inside a porous sachet.

FIG. 2 A schematic side view of the storage container demonstrating the activated carbon cloth enveloped inside a porous sachet.

FIG. 3 A schematic side view of the storage container demonstrating the activated media particulates inside meshed pockets that are attached to the activated carbon cloth with the whole assembly enveloped inside a porous sachet.

FIG. 4 A schematic side view of the storage container demonstrating the activated media particulates stored inside an activated carbon cloth packet that is enveloped inside a porous sachet.

FIG. 5 A schematic side view of the storage container demonstrating the activated media particulates inside a meshed packet that lies besides an activated carbon cloth with the whole assembly is covered by a porous sachet.

FIG. 6 A schematic side view of the storage container demonstrating activated media particulates inside a meshed packet that is covered by a porous sachet.

FIG. 7 A schematic view of the blood circuit between a donor and apheresis system (two needles access) demonstrating the resin chamber on the blood return line.

FIG. 8 A schematic view of the blood circuit between a donor and apheresis system (one needle access) demonstrating the resin chamber on the blood return line.

FIG. 9 A schematic view of the resin chamber.

FIG. 10 A schematic view of the resin chamber.

### DETAILED DESCRIPTION OF THE INVENTION

It should be apparent to those skilled in the art to which the present invention pertains that a number of techniques can be employed to provide means that improves platelet concentrate storage conditions by maintaining the level of the pH in the solution, and reducing the pathogen count in the transfused product. These improving means can also apply to other blood products.

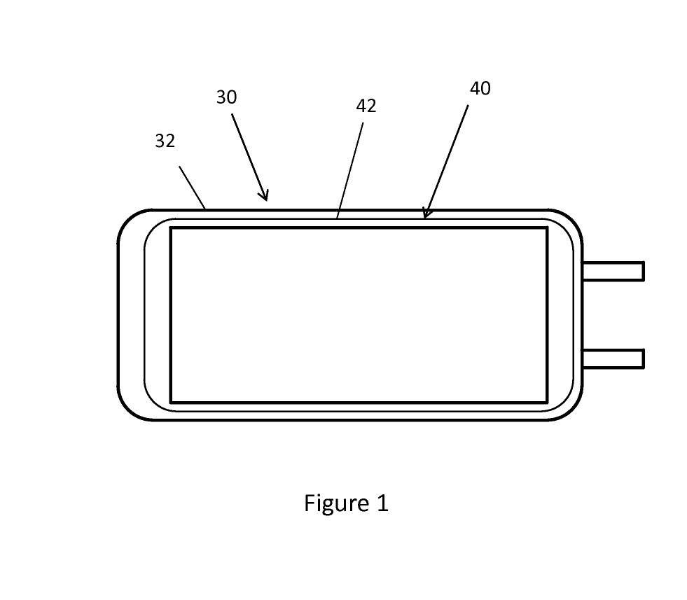

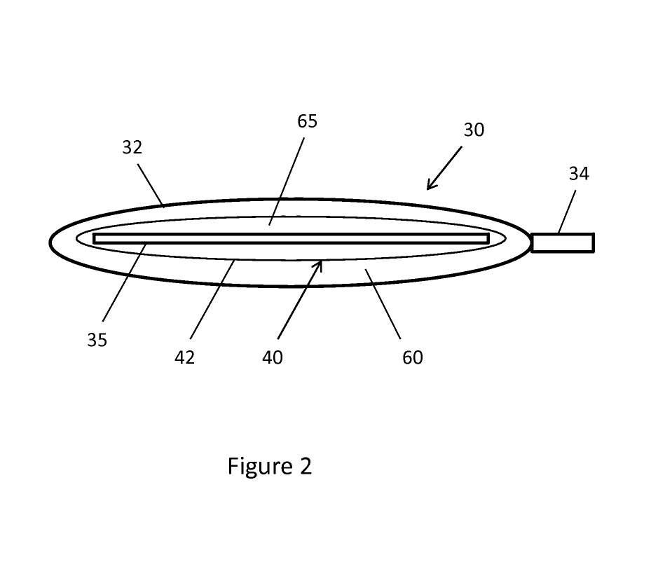

Referring to FIG. 1, a top view of the storage container, and FIG. 2, a cross sectional view of the container. The storage container 30 is typically made of welded plastic sheets that form the outer wall 32. A port 34 is used to communicate fluids between the inner and the outer parts of the container. The adsorbent cloth 35 extends longitudinally inside the container. In the preferred embodiment the adsorbent cloth is Zorflex activated carbon cloth. More particular Zorflex VB and Zorflex VB Plus. The adsorbent cloth is completely enveloped by a sachet 40 that it is made of porous membrane 42. This membrane has a porosity that allows bacteria and viruses suspended in the plasma to pass through with the plasma. The membrane porosity is small enough to prevent any access of platelets, leukocytes, and RBC through the membrane. In some applications, the sachet 40 can be coated with hydrogel polymers such as pHEMA, PEG, PVA, PVP, or other hydrogel. As it is depicted in FIG. 2, the porous membrane 42 divides the space inside the storage container in to two separate zones. The first zone 60 is defined by the space occupied between the inner surface of wall 32 and the outer surface of the sachet 40. The second zone 65 is defined by the space occupied inside the sachet 40.

In blood banks, platelet rich plasma or concentrated platelet solution are introduced in the storage container that is placed on a shaking platform at 22° C. The storage container 30 in the current invention receives the concentrated platelet solution in a normal way and the container is placed on a shaker with a constant horizontal agitation at approximately 70 to 80 cycles per minute and at 22° C. The concentrated platelet solution that is mainly a mixture of platelets and plasma move inside the container due to the platform movement. This movement generates plasma flow between the two zones in and out of the sachet through the porous membrane 42. Plasma can flow through the porous membrane. Bacteria, viruses, cytokines, toxins, endotoxins, and other micro-organisms that are suspended in the plasma, flow through the membrane as well. The porosity size of the membrane allow for these pathogens to pass through and enter in to the sachet. The Platelets have a larger size of the membrane pores therefore; they cannot enter inside the sachet. The pathogens that enter the sachet come in contact with the adsorbent media which is made of activated carbon cloth. The adsorbent media is made of activated carbon fibers that have very large surface area. The pathogens stick to the surface of the adsorbent media and become captured inside the sachet. Platelets and other blood cells inside the storage container, remain in the area outside the sachet. As the pathogens enter the sachet and become trapped inside, they are readily separated from the platelet concentrate. Therefore the number of the pathogens in the platelet concentrate drop. When the concentrated platelets solution is used for transfusion, it has a lower population of pathogens.

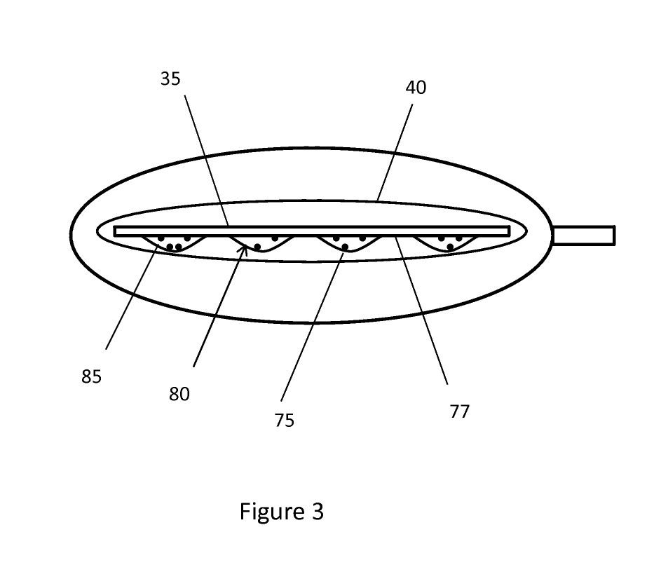

In another embodiment of the invention, other adsorptive particulates are added to the activated carbon cloth to increase the adsorption capacity of the media inside the sachet. Referring to FIG. 3 adsorbent particulates 75 are captured in special pockets 80 that are formed by joining a meshed sheet 85 to the adsorbent cloth 35 at spots 77. The mesh could have a porosity ranging from 50 μm to 300 μm depending on adsorbent particulate size. The mesh porosity is to allow for the plasma to flow freely in to the pocket containing the adsorbent without having the adsorbing particulates exiting the pocket. Typically in most cases the mesh size is 170 μm. Furthermore, these particulates 75 could be mad of activated carbon having granular, pallet, or spherical shapes. These particulates could also be made of porous polymeric material or resins having different shapes and most likely spherical shape. These particulate resins can also be characterized as ion exchange resin. These resins could be of the family of Purolite, Amberlite, Optipore, or Dowex. In different embodiment of this invention, pockets 80 could be formed by joining meshed sheet 85 to both sides of the adsorbent cloth 35.

For use in the platelet storage system of the present invention, anion exchange resins, and more particularly weakly basic anion exchange resins, are preferred. These weakly basic resin exhibit minimum exchange capacity above a pH of 7.0 and are good to experience reactions with anions where they only adsorb acids from the surrounding medium. Such resins which have the additional properties of adsorbing acids from organic reaction mixtures, exchanging anions in a slightly acidic media, a high exchange capacity, low swelling properties and a tendency to adsorb bacteria from the surrounding solution are particularly advantageous. Glucose in the platelet concentrate solution starts to metabolize. In case of insufficient oxygen supply to the storage bag, glucose is metabolized anaerobically resulting in the production of lactic acid. The excess generation of this lactic acid causes a drop in the stored solution pH. If the pH level drops from 6.8 to 6.0, the platelets progressively change shape from discs to spheres. If the pH falls below 6.0, then platelets become nonviable after infusion in vivo. The presence of the anionic exchange resin in the storage bag and its capability in adsorbing the lactic acid from the medium, it neutralizes the pH in the solution and establishes a favorable environment for the platelets. Therefore the platelets remain viable and effective for post storage in vivo infusion. Such resins are commercially available under the trade name of Amberlite from Rohm & Haas Company, weakly basic, polystyrene-polyamine type anion exchange resin having a styrene-divinylbenzene matrix. Other commercially available ion exchange resins are Purosorb and Macronet from Purolite and Dowex from Dow Chemical.

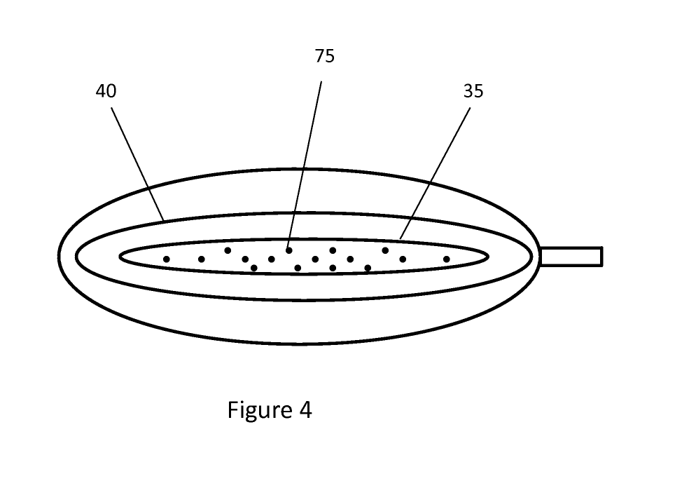

In another embodiment of the invention, adsorbent particulates are amassed in a pouch made of the activated carbon cloth that is inserted in a sachet inside the storage container. Referring to FIG. 4 adsorbent particulates 75 are stored inside a pouch 90 that is made of the same materials as the adsorbent cloth 35. The whole pouch including the adsorbent particulates is placed inside a sachet 40 that is made of a porous membrane 42. The sachet is situated inside the concentrated platelets storage bag where the plasma is free to flow in and out of the sachet. It is clear that the porosity of the sachet membrane does not allow the platelets or any blood cell to pass through.

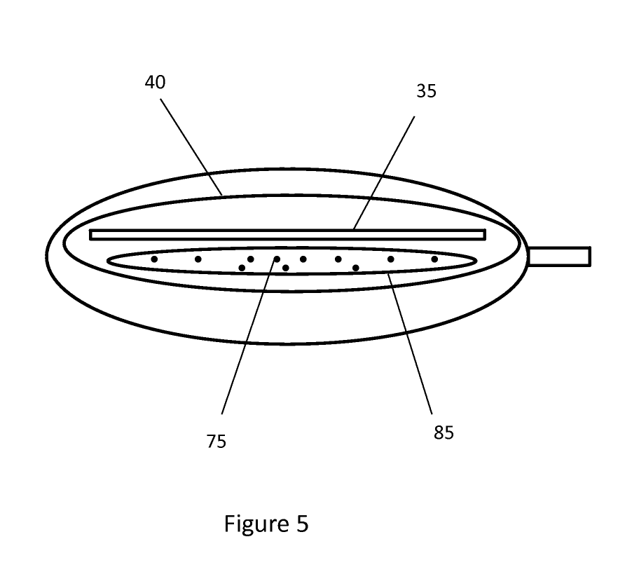

FIG. 5 demonstrates another embodiment where the adsorbent particulate 75 are stored in a pouch 95 made of the meshed sheet 87 with a porosity ranging between 50μ to 300μ as the same sheet material used in the embodiment of FIG. 3. In this particular embodiment the pouch 95 extends longitudinally along the storage container the same as the adsorbent cloth 35. A sachet 40 includes both of the pouch 95 and the adsorbent cloth 35 and it is placed inside the storage container.

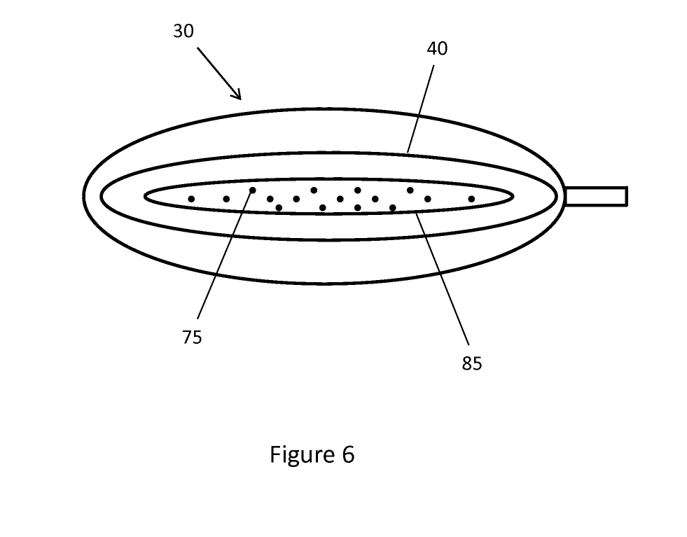

In another embodiment demonstrated in FIG. 6 the pouch 95 encompassing adsorbent particulates 75, is placed inside the sachet 40 that extends within the storage container. The pouch 95 is built with meshed material with porosity ranging between 50 μm to 300 μm. The sachet is built with a membrane having a porosity that allows the plasma to pass through but preventing the platelets. Multiple packets can be used in the same storage container. Different packets can have different types of adsorptive particulates. For example one packet can have activated carbon spheres or granules and another packet can have polymeric resin beads or ionic exchange beads.

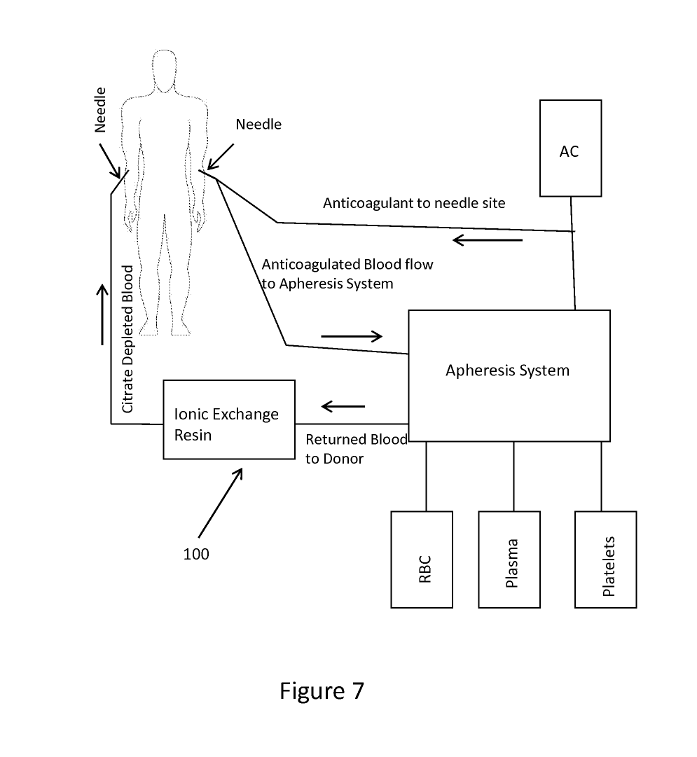

FIG. 7 depicting a schematic view of the connections between a donor and an apheresis system. The anticoagulant (AC) fluid is pumped to the vein puncture site to be mixed with the drawn blood at the needle. Typically, the AC flow line is hooked to a pump on the apheresis system in order to meter the exact ratio of AC to the drawn blood. This ratio for the apheresis system is 1:16 (by volume AC to blood) for most commonly used AC. As the drawn blood is mixed with AC it becomes resistant to clotting and it is called anticoagulated blood. The blood is processed by the apheresis system depending on the type of the system and the procedure.

For example TerumoBCT Trima system has a protocol to remove platelets from the blood and store them in designated bags and return the rest of the blood components back to the donor. Fenwal Inc. Amicus system does the same. Haemonetics MCS8150 system and Fenwal Alyx system process the anticoagulated blood to remove the RBC's and store them in special bags while returning the rest of the blood components back to the donor. Another apheresis system is Haemonetics PCS system that processes the blood by removing the plasma and then returns the rest of the components back to the donor. In all these systems most of the AC that was mixed with the blood is infused into the donor with the returned blood components. FIG. 7 demonstrates a chamber containing ion exchange resins that is placed on the path of the returned blood components. As the apheresis system pumps the returned components back to the donor, the flow passes through a bed of ionic resins. These polymeric resins are weak basic, anion exchange resins that are specialized to react with weak acid solutions that have a pH level of 4.5 or greater to form a safe buffer. Therefore the effect of the citrate in the returned blood components solution is neutralized.

Referring to AABB (American Association of Blood Banks) Technical Manual 17^{th} edition, the approved types of anticoagulants, their ratio to collected blood, and composition are listed in Table 1.

TABLE 1

| | | | CPDA- | | | |
|---|---|---|---|---|---|---|
| Variable | CPD | CP2D | 1 | ACD-A | ACD-B | 4% Citrate |
| pH | 5.3-5.9 | 5.3-5.9 | 5.3-5.9 | 4.5-5.5 | 4.5-5.5 | 6.4-7.5 |
| Ratio (ml | 1.4:10 | 1.4:10 | 1.4:10 | 1.5:10 | 2.5:10 | 0.625:10 |
| solution/ | | | | | | |
| Blood) | | | | | | |
| Content | | | | | | |
| (mg in | | | | | | |
| 63 ml | | | | | | |
| solution) | | | | | | |
| Sodium | 1660 | 1660 | 1660 | 1386 | 832 | 2520 |
| Citrate | | | | | | |
| Citric acid | 206 | 206 | 206 | 504 | 504 | As needed |
| | | | | | | for pH |
| | | | | | | Adjust- |
| | | | | | | ment |
| Dextrose | 1610 | 3220 | 2010 | 1599 | 956 | |
| Monobasic | 140 | 140 | 140 | | | |
| sodium | | | | | | |
| phosphate | | | | | | |
| Adenine | 0 | 0 | 17.3 | | | |

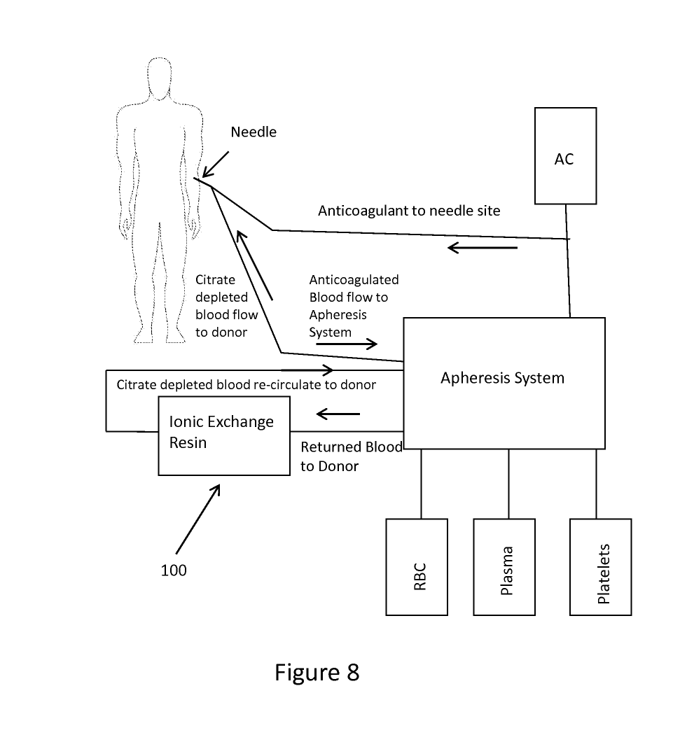

FIG. 8 depicts the configurations of the blood and blood components flow path between the donor and the apheresis system that utilizes one needle access for blood draw and return. The system ensures the looping of the return blood path to pass through the ionic resin exchange chamber before it is pumped to the donor.

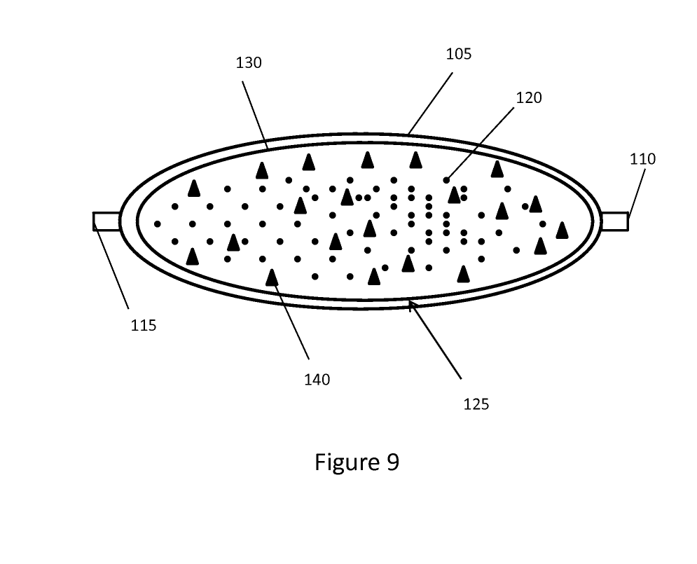

FIG. 9 shows a schematic configuration of a resin chamber 100. This chamber is designed to allow for the returned blood to flow through and thoroughly mix with the resin contained inside. The housing 105 of the chamber is made of material that can be sterilized. It could have a rigid, semi-rigid, or flexible structure. The blood enters the chamber through the inlet port 110, and exits out through the outlet port 115. Resin particulates 120 are amassed inside a pouch 125 that is made of a screened mesh 130. Monofilament synthetic fibers can be woven very precisely to create textiles with narrow pore distribution. This precision weaving process creates fine mesh woven fabrics with apertures (hole sizes) as small as 1 micron. For the present invention, the screen mesh will have porosity of 100 μm to 200 μm enough to let the blood to pass freely through while trapping the resin inside. A 150μ mesh size is used as the size of the resin particulates range between (300 μm and 1,200 μm). These resins could have spherical shape. Activated carbon media 140 (particulates, spheres, or cloth) can be used with or without the resins 120 to adsorb free hemoglobin from the returned blood product. The activated carbon media can adsorb citrate from the returned blood products. The synthetic mesh could be made of polyester, polypropylene, or nylon materials and can be purchased from (Industrial Netting, 7681 Setzler Pkwy N., Minneapolis, Minn.) or from (SEFAR, 111 Calumet Street, Depew, N.Y.). The pouch 125 takes the shape of the inner cavity of the chamber. The pouch is filled with resin (or activated carbon) that is selected for appropriate buffering of the acid solution. The volume of the resin is enough to handle all the solution that passes through the chamber. Returned blood components with citrate enter the chamber through inlet port 110. It flows through the resin mass or activated carbon mass inside the chamber 100. Ion exchange take place between the resin and the solution and some ions are absorbed by the resin or activated carbon media. The blood components solution is neutralized and becomes citrate free as it exits the chamber through port 115 and continues to be infused back into the donor.

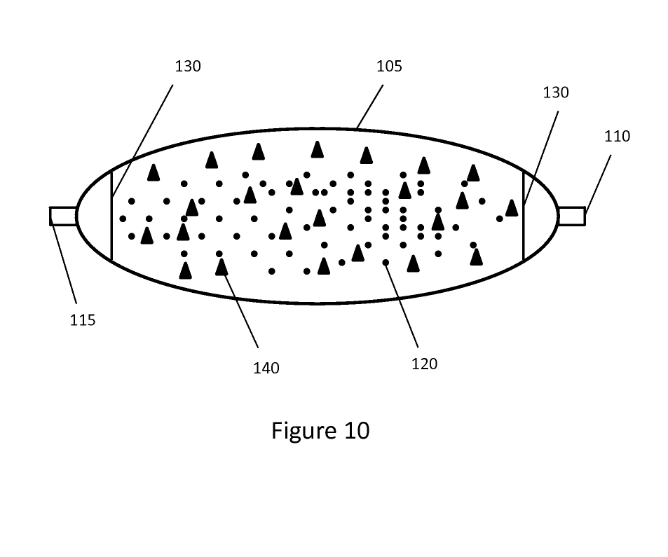

FIG. 10 depicts another configuration of the resin chamber 100. The ion exchange resin particulates (or activated carbon media 140) are stored inside the housing 105. Special screen mesh are placed between the inlet port 110 and the particulates 120 in order to confine the particulates inside the housing and prevent them from escaping through the inlet or outlet port.

Having now described a few embodiments of the invention, it should be apparent to those skilled in the art that the foregoing is merely illustrative and not limiting, having been presented by way of example only. Numerous modifications and other embodiments are within the scope of ordinary skill in the art and are contemplated as falling within the scope of the invention as defined by the appended claims and equivalents thereto. The contents of all references, issued patents, and published patent applications cited throughout this application are hereby incorporated by reference. The appropriate components, processes, and methods of those patents, applications and other documents may be selected for the present invention and embodiments thereof.

What is claimed is:

1. A container used for platelets storage comprising one or more pouches having porous walls that allow for fluid flow to pass through while preventing blood cells from entering the pouches,
activated carbon fibers in woven or knitted cloth structure with surface area greater than 500 m²/g are embedded inside said pouches,
stored fluid flows through the pores inside and out of said pouches, pathogens suspended in the stored fluid pass through the pores inside the pouches and contact carbon fibers, whereas activated carbon fibers adsorb the pathogens on contact,
wherein said adsorbed pathogens are isolated from the platelets that are kept outside the pouches and used for reinfusion.

2. The platelet storage container defined in claim 1 wherein said pouches having walls with porosity of 3 μm or less.

3. The platelet storage container defined in claim 1 wherein said pouches having walls with porosity impermeable to blood cells.

4. The platelet storage container defined in claim 1 wherein said pouches include polymeric resin beads in addition to the activated carbon fibers cloth.

5. The platelet storage container defined in claim 1 wherein said pouches include activated carbon particulates or beads in addition to the activated carbon fibers cloth.

6. The platelet storage container defined in claim 1 wherein said resin beads are made of Polystyrene, Styrene-Divinylbenzene, Polystyrene-Polyamine, or Acrylic matrix.

7. The platelet storage container defined in claim 1 wherein said resin beads have a surface area greater than 400 m²/g.

8. The platelet storage container defined in claim 1 wherein said resin beads have a surface area ranging between 490 m²/g and 1200 m²/g.

9. The platelet storage container defined in claim 1 wherein said resin beads are ion exchange resin.

10. The platelet storage container defined in claim 1 wherein said resin beads are weak base anion exchange resin.

11. The platelet storage container defined in claim 1 wherein said resin beads are strong base anion exchange resin.

12. The platelet storage container defined in claim 1 wherein said activated carbon cloth or carbon particulates are coated with biocompatible material selected from the family of Poly (2-hydroxyethyl methacrylate), Polyvinyl pyrrolidone, Poly Ethylene Glycol, Polyvinyl Alcohol, Cellulose, Silicone, and Poly-Methyl Methacrylate (PMMA).

13. The platelet storage container defined in claim 4 wherein said resin beads are coated with biocompatible material selected from the family of Poly (2-hydroxyethyl methacrylate), Polyvinyl pyrrolidone, Poly Ethylene Glycol, Polyvinyl Alcohol, Cellulose, Silicone, and Poly-Methyl Methacrylate (PMMA).

14. The platelet storage container defined in claim 1 wherein said pouches having walls with porosity of 3 μm or less.

15. The platelet storage container defined in claim 1 wherein said platelets are human platelets.

16. The platelet storage container defined in claim 1 wherein said activated carbon cloth has a surface area ranging between 500 m²/g and 2000 m²/g.

17. The platelet storage container defined in claim 1 wherein said activated carbon cloth has a surface area about 1500 m²/g.

18. A container used for platelets storage comprising one or more pouches having porous walls with 3 μm porosity or less,
activated carbon fibers in woven or knitted cloth structure with surface area greater than 500 m²/g are embedded inside said pouches,
Whereas said container comprises fluid containment walls that are permeable to O₂ and CO₂,
when the container is agitated, stored fluid flows through the pores inside and out of said pouches, pathogens suspended in the stored fluid pass through the pores inside the pouches and contact carbon fibers, whereas activated carbon fibers adsorb the pathogens on contact,
wherein said adsorbed pathogens are isolated from the platelets that are kept outside the pouches and used for reinfusion.

19. A container used for platelets storage comprising one or more pouches having porous walls that allow for fluid flow to pass through while preventing blood cells from entering the pouches,
activated carbon fibers in woven or knitted cloth structure with surface area greater than 500 m²/g are embedded inside said pouches,
Whereas said container is placed on a cycling platform for storage at temperature ranging between 20° C. and 24° C.,
stored fluid flows through the pores inside and out of said pouches, pathogens suspended in the stored fluid pass through the pores inside the pouches and contact carbon fibers, whereas activated carbon fibers adsorb the pathogens on contact,
wherein said adsorbed pathogens are isolated from the platelets that are kept outside the pouches and used for reinfusion.
